(19) United States
(12) Patent Application Publication
(10) Pub. No.: US 2012/0019625 A1
(43) Pub. Date: Jan. 26, 2012

(54) PARALLAX IMAGE GENERATION APPARATUS AND METHOD

(76) Inventors: Nao MISHIMA, Inagi-shi (JP); Takeshi Mita, Yokohama-shi (JP); Masahiro Baba, Yokohama-shi (JP)

(21) Appl. No.: 13/052,793

(22) Filed: Mar. 21, 2011

(30) Foreign Application Priority Data
Jul. 26, 2010 (JP) 2010-167471

(51) Int. Cl. H04N 13/02

(52) U.S. Cl. 348/49; 348/E13.074

(57) ABSTRACT

According to one embodiment, a parallax image generation apparatus comprises a calculation unit and a generation unit. The calculation unit is configured to calculate a distance between a target pixel value of a target pixel contained in an input image and a representative pixel value, and calculating a depth of the target pixel in a stereoscopic space in accordance with the distance. The generation unit is configured to generate, based on the depth, at least one parallax image corresponding to a view point different from that of the input image.

### CROSS-REFERENCE TO RELATED APPLICATIONS

This application is based upon and claims the benefit of priority from Japanese Patent Application No. 2010-167471, filed Jul. 26, 2010; the entire contents of which are incorporated herein by reference.

### FIELD

Embodiments described herein relate generally to the generation of a parallax image.

### BACKGROUND

Recently, a method of generating at least one parallax image based on a two-dimensional input image (e.g., a still image or each frame contained in a moving picture) is attracting attention. This method can stereoscopically display still image contents and moving picture contents not formed for stereoscopy.

As a method of generating a parallax image from pixel values, there is a technique of synthesizing a plurality of basic depth models, adding the depths by using an R signal, and subtracting the depths by using a B signal. However, a depth conflict sometimes occurs because the convexity and concavity relationship between red and blue is fixed.

### BRIEF DESCRIPTION OF THE DRAWINGS

FIG. 1 is a block diagram exemplarily showing a parallax image generation apparatus according to a first embodiment;

FIG. 2 is a flowchart exemplarily showing the operation of the parallax image generation apparatus shown in FIG. 1;

FIG. 3 is a view for explaining a parallax vector;

FIG. 4 is a view for explaining a parallax image;

FIG. 5 is a block diagram exemplarily showing a parallax image generation apparatus according to a second embodiment; and

FIG. 6 is a block diagram exemplarily showing a parallax image generation apparatus according to a third embodiment.

### DETAILED DESCRIPTION

Embodiments will be explained below with reference to the accompanying drawing.

In general, according to one embodiment, a parallax image generation apparatus comprises a calculation unit and a generation unit. The calculation unit is configured to calculate a distance between a target pixel value of a target pixel contained in an input image and a representative pixel value, and calculating a depth of the target pixel in a stereoscopic space in accordance with the distance. The generation unit is configured to generate, based on the depth, at least one parallax image corresponding to a view point different from that of the input image.

The distance can include an absolute value of a difference between the target pixel value and the representative pixel value, or a square of the difference between the values, and a value related to the absolute value or the square.

Note that the same reference numbers denote arrangements or processes that operate in the same manner, and a repetitive explanation will be omitted.

### First Embodiment

A parallax image generation apparatus according to a first embodiment generates, based on an input image, at least one parallax image corresponding to a view point different from that of the input image. When the input image is, e.g., a two-dimensional image, therefore, stereoscopy can be performed by displaying parallax images having a parallax. Also, when the input image is a stereoscopic image having a predetermined parallax number, it is possible to generate parallax images having a parallax number larger than the original parallax number (e.g., it is possible to generate nine parallax images from two parallax images). In the following embodiments, an example in which an input image is a two-dimensional image and at least one parallax image corresponding to a view point different from that of the input image is generated based on the input image will be described.

For example, stereoscopy using stereoscopic glasses requires two images, i.e., left-eye and right-eye images. This parallax image generation apparatus can generate both the left-eye and right-eye images from an input image, or use an input image as one of the left-eye and right-eye images and generate the other from the input image. Furthermore, for naked-eye stereoscopy, this parallax image generation apparatus generates parallax images in number corresponding to the type of this naked-eye stereoscopy. Also, the range of a depth z in a stereoscopic space reproduced by parallax images generated by this parallax image generation apparatus is 0≦z≦Z where z=0 indicates the foremost side in this stereoscopic space, and z=Z indicates the backmost side in the stereoscopic space.

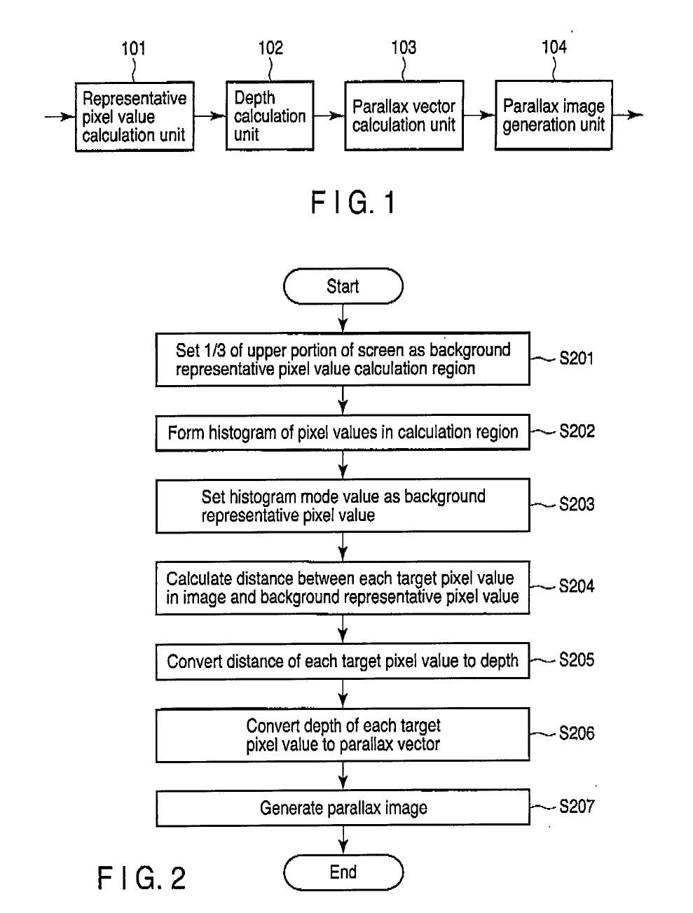

As shown in FIG. 1, the parallax image generation apparatus according to this embodiment includes a representative pixel value calculation unit 101, depth calculation unit 102, parallax vector calculation unit 103, and parallax image generation unit 104.

The representative pixel value calculation unit 101 calculates a representative pixel value based on pixel values in at least a partial region of an input image.

In this embodiment, the pixel value indicates a part or the whole of RGB signal values, the UV signal (color difference signal) value or Y signal (luminance signal) value of a YUV signal obtained by converting the RGB signal, or the signal value of a uniform color space LUV or Lab. However, a signal value defined by a color space different from those enumerated above is also applicable as the pixel value in this embodiment. For the sake of simplicity, the pixel value means the UV signal value in the following explanation. That is, the pixel value of a coordinate point (x,y) is represented by (U(x,y),V(x,y)).

The representative pixel value is a pixel value as the basis for depth calculation according to this embodiment as will be described later. More specifically, the representative pixel value sometimes means a background representative pixel value positioned on at least the back side (e.g., the backmost side) in a stereoscopic space reproduced by parallax images generated by this parallax image generation apparatus. Also, the representative pixel value sometimes means a foreground representative pixel value positioned on at least the fore side (e.g., the foremost side) in a stereoscopic space reproduced by parallax images generated by this parallax image generation apparatus. A practical calculation method of the background representative pixel value will be explained below.

The representative pixel value calculation unit 101 sets the calculation region of the background representative pixel value. For example, it is empirically known that the upper portion of the screen is often the background region. Therefore, the representative pixel value calculation unit 101 can set a region such as ⅓ of the upper portion of an input image as the background representative pixel value calculation region. Alternatively, the representative pixel value calculation unit 101 can set the whole input image as the background representative pixel value calculation region. Furthermore, as disclosed in Japanese Patent No. 4214976, the representative pixel value calculation unit 101 can set a region indicating the back side in a prepared basic depth model, as the background representative pixel value calculation region. The representative pixel value calculation unit 101 calculates the statistical amount of pixel values in the background representative pixel value calculation region, as the background representative pixel value.

For example, the representative pixel value calculation unit 101 forms a histogram h(U,V) of pixel values in the background representative pixel value calculation region in accordance with

h(U(x,y),V(x,y))←h(U(x,y),V(x,y)+1 (1)

Expression (1) means that the number of times of appearance of a pixel value (U,V) is counted for all coordinates in the background representative pixel value calculation region. Note that in order to remove noise, the representative pixel value calculation unit 101 can also smooth the histogram h(U,V) formed in accordance with expression (1). The representative pixel value calculation unit 101 searches for the mode value of the pixel values in the calculation region from the histogram h(U,V) in accordance with

$$( {U}_{m ax} , {V}_{max} ) = {arg max}_{U , V} h ( U , V ) \qquad ( 2 )$$

Expression (2) means that a pixel value (Uₘₐₓ,Vₘₐₓ) that maximizes the histogram h(U,V) is searched for. The representative pixel value calculation unit 101 can calculate the mode value (Uₘₐₓ,Vₘₐₓ) as the background representative pixel value.

The representative pixel value calculation unit 101 can also form two one-dimensional histograms h_{U}(U) and h_{V}(V), instead of the two-dimensional histogram h(U,V), in accordance with

$$\{ \begin{matrix}{h}_{U} ( U ( x , y ) ) ← {h}_{U} ( U ( x , y ) ) + 1 \\ {h}_{V} ( V ( x , y ) ) ← {h}_{V} ( V ( x , y ) ) + 1\end{matrix} \qquad ( 3 )$$

In order to remove noise, the representative pixel value calculation unit 101 may smooth the histograms h_{U}(U) and h_{V}(V) formed in accordance with expressions (3). The representative pixel value calculation unit 101 searches for the mode value of the pixel values in the calculation region from the histograms h_{U}(U) and h_{V}(V) in accordance with

$$\{ \begin{matrix}{U}_{max} = {arg max}_{U} {h}_{U} ( U ) \\ {V}_{max} = {arg max}_{V} {h}_{V} ( V )\end{matrix} \qquad ( 4 )$$

The representative pixel value calculation unit 101 can also calculate a mode value combination (Uₘₐₓ,Vₘₐₓ) found from the two one-dimensional histograms h_{U}(U) and h_{V}(V), as the background representative pixel value.

Furthermore, the representative pixel value calculation unit 101 may take account of pixel values in the foreground region, when forming the histograms indicated by expressions (1) and (3). For example, it is empirically known that the lower portion of the screen is often the foreground region, so it is possible to set, e.g., ⅓ of the lower portion of an input image as the foreground region. Alternatively, as disclosed in Japanese Patent No. 4214976, the representative pixel value calculation unit 101 can set a region indicating the fore side in a prepared basic depth model as the foreground region. Since it is highly likely that pixel values in the foreground region are inappropriate as the background representative pixel value, the representative pixel value calculation unit 101 may perform adjustment by taking the foreground region into account in accordance with expression (5) below, when forming the histogram h(U,V) of expression (1). This adjustment makes it possible to calculate an appropriate background representative pixel value even when the same pixel values as in the foreground region exist in the background representative pixel value calculation region.

h(U(x,y),V(x,h(U(x,y),V(x,y))−1 (5)

Expression (5) indicates that the number of times of appearance of the pixel value (U,V) is canceled from the histogram h(U,V) for all coordinates in the foreground region. Alternatively, the representative pixel value calculation unit 101 can perform the same or similar adjustment as indicated by expression (5) when forming the histograms h_{U}(U) and h_{V}(V) of expressions (3).

In addition, the representative pixel value calculation unit 101 can calculate the mean value or median value, instead of the mode value (Uₘₐₓ,Vₘₐₓ) in the above-described calculation region, as the background representative pixel value. For example, the representative pixel value calculation unit 101 can calculate the mean value in accordance with

$$\{ \begin{matrix}\overline{U} = \frac{1}{N} {\sum }_{x , y} U ( x , y ) \\ \overline{V} = \frac{1}{N} {\sum }_{x , y} V ( x , y )\end{matrix} \qquad ( 6 )$$

where N indicates the total number of pixels in the calculation region. The representative pixel value calculation unit 101 can also calculate the median value in accordance with

$$( \hat{U} , \hat{V} ) = {arg min}_{U , V} {\sum }_{x , y} ( {( U - U ( x , y ) )}^{2} + {( V - V ( x , y ) )}^{2} ) \qquad ( 7 )$$

When an input image is one of a plurality of frames contained in a moving picture, it is also possible to set a plurality of calculation regions in a plurality of (past or future) frames including the input image, and calculate a background representative pixel value to be applied to the input image. Furthermore, a common background representative pixel value can be used in the same scene by combining a scene detection method with the above method.

Note that the foreground representative pixel value can be calculated by properly changing the explanation of each calculation method of the background representative pixel value described above. More specifically, it is only necessary to change “the background representative pixel value” to “the foreground representative pixel value” and “the foreground region” to “the background region” in the above-described explanation. However, the foreground representative pixel value calculation region and the background region are set as follows. For example, it is empirically known that the lower portion of the screen is often the foreground region, so the representative pixel value calculation unit 101 can set a region such as ⅓ of the lower portion of an input image as the foreground representative pixel value calculation region. Alternatively, the representative pixel value calculation unit 101 can set the whole input image as the foreground representative pixel value calculation region. In addition, as disclosed in Japanese Patent No. 4214976, the representative pixel value calculation unit 101 can set a region indicating the fore side in a prepared basic depth model as the foreground representative pixel value calculation region. Also, since it is empirically known that the upper portion of the screen is often the background region, it is possible to set, e.g., ⅓ of the upper portion of an input image as the background region. Alternatively, as disclosed in Japanese Patent No. 4214976, the representative pixel value calculation unit 101 can set a region indicating the back side in a prepared basic depth model as the background region.

It is possible to omit the calculations of the background representative pixel value and foreground representative pixel value by using prepared pixel values indicating specific colors as the background representative pixel value and foreground representative pixel value. For example, a pixel value indicating the human skin color (e.g., the mean value of the human skin colors) can be prepared and used as the foreground representative pixel value. This foreground representative pixel value is useful in, e.g., a scene including a person. Also, a pixel value indicating, e.g., black can be prepared and used as the background representative pixel value. This background representative pixel value is useful in a space scene or the like. In addition, typical background colors and foreground colors can be prepared for the background representative pixel value and foreground representative pixel value in accordance with various scenes and genres.

The depth calculation unit 102 calculates the distance between a target pixel value contained in an input image and the representative pixel value, and converts the distance to a corresponding depth.

For example, the depth calculation unit 102 can evaluate the distance between the target pixel value and representative pixel value by the L2 norm (Euclidean distance) of the difference between them. More specifically, the depth calculation unit 102 calculates the distance in accordance with

$$\begin{matrix}D ( x , y ) = {‖ {( U ( x , y ) , V ( x , y ) )}^{T} - {( {U}_{d} , {V}_{d} )}^{T} ‖}_{L 2} \\ = \sqrt{{( U ( x , y ) - {U}_{d} )}^{2} + {( V ( x , y ) - {V}_{d} )}^{2}}\end{matrix} \qquad ( 8 )$$

where D(x,y) represents the distance, (U(x,y),V(x,y)) represents the target pixel value, and (U_{d},V_{d}) represents the representative pixel value.

Alternatively, the depth calculation unit 102 can evaluate the distance between the target pixel value and representative pixel value by the L1 norm (Manhattan distance) of the difference between them. More specifically, the depth calculation unit 102 calculates the distance in accordance with

$$\begin{matrix}D ( x , y ) = {‖ {( U ( x , y ) , V ( x , y ) )}^{T} - {( {U}_{d} , {V}_{d} )}^{T} ‖}_{L 1} \\ = \vert U ( x , y ) - {U}_{d} \vert + \vert V ( x , y ) - {V}_{d} \vert\end{matrix} \qquad ( 9 )$$

Furthermore, the depth calculation unit 102 can also calculate the distance in accordance with

D(x,y)=max(|U(x,y)−U_{d}|,|V(x,y)−V_{d}|) (10)

The depth calculation unit 102 converts the distance D(x,y) calculated as described above to a corresponding depth z(x,y). For example, when the representative pixel value means the background representative pixel value, the depth calculation unit 102 converts the distance D(x,y) to the corresponding depth z(x,y) in accordance with

$$z ( x , y ) = Z - \frac{D ( x , y )}{σ} \qquad ( 11 )$$

where σ is a normalization coefficient of the distance, e.g., the standard deviation between U and V. According to expression (11), the larger the value of the distance D(x,y), the smaller the depth z(x,y) to which the distance D(x,y) is converted, in the stereoscopic space reproduced by a parallax image generated by the parallax image generation apparatus shown in FIG. 1. That is, a target pixel value at a relatively large distance from the background representative pixel value is assigned a relatively small depth in the stereoscopic space.

On the other hand, when the representative pixel value means the foreground representative pixel value, for example, the depth calculation unit 102 converts the distance D(x,y) to the corresponding depth z(x,y) in accordance with

$$z ( x , y ) = \frac{D ( x , y )}{σ} \qquad ( 12 )$$

According to expression (12), the larger the value of the distance D(x,y), the larger the depth z(x,y) to which the distance D(x,y) is converted, in the stereoscopic space reproduced by a parallax image generated by the parallax image generation apparatus shown in FIG. 1. That is, a target pixel value at a relatively large distance from the foreground representative pixel value is assigned a relatively large depth in the stereoscopic space.

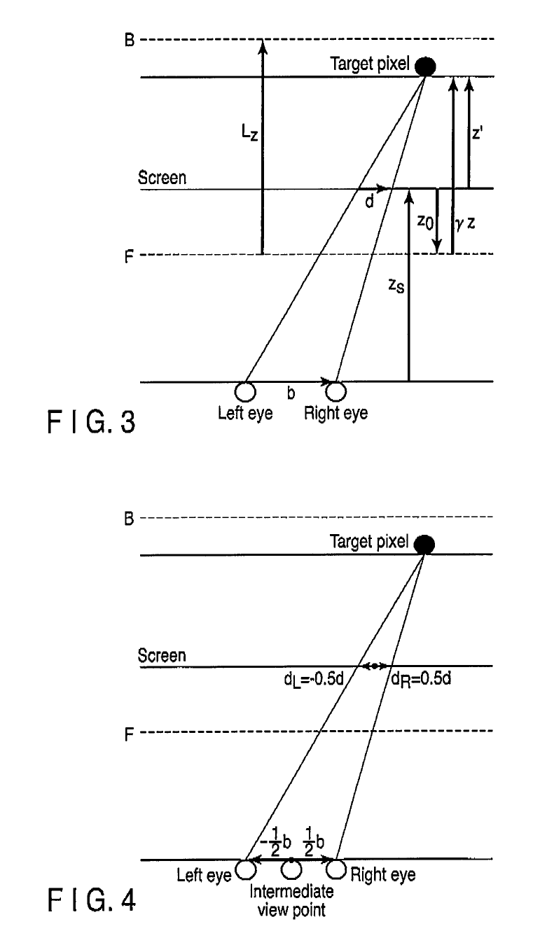

The parallax vector calculation unit 103 converts the depth of each target pixel value calculated by the depth calculation unit 102 to a parallax vector. This conversion from the depth to the parallax vector will be explained below with reference to FIG. 3. In the following explanation, let d [cm] be the parallax vector, b [cm] be the distance between the eyes of an observer, zₛ [cm] be the distance from the eyes of the observer to the screen (on which a parallax image is displayed), z₀ [cm] be the maximum projection distance from the screen to a foreground F in a real space, and L_{z} [cm] be the depth size from the foreground F to a background B in the real space. Of these factors, it is possible to freely set the inter-eye distance b, distance zₛ, maximum projection distance z₀, and depth size L_{z}. For example, a value indicating the actual inter-eye distance of an observer or a predetermined value corresponding to the age, sex, or the like of an observer can be set as the inter-eye distance b. Also, a value corresponding to the actual viewing environment can be set as the distance zₛ. Furthermore, values corresponding to the position and size of a stereoscopic space to be reproduced by parallax images can be set as the maximum projection distance z₀ and depth size L_{z}.

The depth of the target pixel value in the real space can be represented by γz [cm] based on the foreground F. In γz [cm], z represents the depth of the target pixel value calculated by the depth calculation unit 102, and γ [cm] is a conversion coefficient derived from

$$γ = \frac{{L}_{Z}}{{z}_{max}} \qquad ( 13 )$$

where zₘₐₓ is derived from

zₘₐₓ=Z (14)

The depth of the target pixel value in the real space can be represented by z′=(γz−z₀) [cm] based on the screen. As shown in FIG. 3, expression (15) below holds due to the similarity of triangles.

$$b \text{:} d = {z}^{′} \text{:} ( {z}_{s} + {z}^{′} ) \\ d = b ( \frac{{z}^{′}}{{z}_{s} + {z}^{′}} ) \qquad ( 15 )$$

As described above, the parallax vector calculation unit 103 calculates the parallax vector d [cm]. The parallax vector calculation unit 103 may also calculate the parallax vector d [cm] reduced to a pixel unit in accordance with

$${d}_{pixel} = \frac{Image Resolution [ pixel ]}{Screen Size [ cm ]} d \qquad ( 16 )$$

where dₚᵢₓₑₗ [pixel] represents the parallax vector reduced to a pixel unit, “image resolution” represents the total number of pixels on one line of an input image, and “screen size” represents a size [cm] corresponding to the above-mentioned line on the screen for displaying parallax images.

The parallax image generation unit 104 generates at least one parallax image based on the parallax vector calculated for each target pixel value by the parallax vector calculation unit 103. For example, as shown in FIG. 4, when an input image corresponds to a view point intermediate between the left and right eyes, the parallax image generation unit 104 can calculate a left-eye parallax vector d_{L} and right-eye parallax vector d_{R} in accordance with

$$\{ \begin{matrix}{d}_{L} = - \frac{1}{2} d \\ {d}_{R} = \frac{1}{2} d\end{matrix} \qquad ( 17 )$$

The parallax image generation unit 104 generates a left-eye parallax image by shifting (moving) each target pixel value p(x,y) in accordance with the left-eye parallax vector d_{L} calculated for the target pixel value. Also, the parallax image generation unit 104 generates a right-eye parallax image by shifting the target pixel value p(x,y) in accordance with the right-eye parallax vector d_{R} calculated for the target pixel value. Note that a pixel is sometimes lost in the left-eye or right-eye parallax image. In this case, the lost pixel may be generated by interpolation from surrounding pixels. In addition, the parallax image generation unit 104 can generate desired two parallax images or multiple parallax images by appropriately converting the parallax vector d in accordance with a desired stereoscopic method.

An example of the operation of the parallax image generation apparatus shown in FIG. 1 will be explained below with reference to FIG. 2.

The representative pixel value calculation unit 101 sets ⅓ of the upper portion of the screen as the background representative pixel value calculation region (step S201). When an input image is one of a plurality of frames contained in a moving picture, the calculation region can be the same in this moving picture, and can also be changed for each frame or scene.

The representative pixel value calculation unit 101 forms a histogram of pixel values in the calculation region set in step 5201 (step S202). The representative pixel value calculation unit 101 searches for a mode value in the histogram formed in step S202, and sets the mode value as a background representative pixel value (step S203). The representative pixel value calculation unit 101 inputs the background representative pixel value set in step 5203 to the depth calculation unit 102.

The depth calculation unit 102 calculates the distance between each target pixel value contained in the input image and the background representative pixel value set in step S203 (step S204). The depth calculation unit 102 converts the distance between each target pixel value and the background representative pixel value, which is calculated in step S204, to a depth (step S205). In steps S204 and S205, the depth is assigned to each target pixel value contained in the input image.

The parallax vector calculation unit 103 converts the depth assigned to each target pixel value in steps S204 and S205 to a parallax vector (step S206). In step S206, the parallax vector is assigned to each target pixel value contained in the input image.

The parallax image generation unit 104 properly converts the parallax vector assigned to each target pixel value in step S206, in order to generate a desired parallax image. Then, the parallax image generation unit 104 shifts each target pixel value in accordance with the converted parallax vector, thereby generating a desired parallax image (step S207).

As has been explained above, the parallax image generation apparatus according to the first embodiment calculates a depth to be assigned to a target pixel value in accordance with the distance from a representative pixel value as the basis for the depth. Accordingly, the parallax image generation apparatus according to the first embodiment can calculate the depth by an algorithm simpler than that of a method using motion information or the like. In addition, the parallax image generation apparatus according to this embodiment can calculate a proper depth based on the color contrast between a target pixel value and representative pixel value, regardless of absolute color (e.g., blue or red) indicated by the target pixel value.

The parallax image generation apparatus according to the first embodiment calculates a depth to be assigned to each target pixel value contained in an input image during the process of generating a parallax image. If the depth is calculated by a simple algorithm, a parallax image can be generated at a high speed (i.e., with a small delay) from the input image.

### Second Embodiment

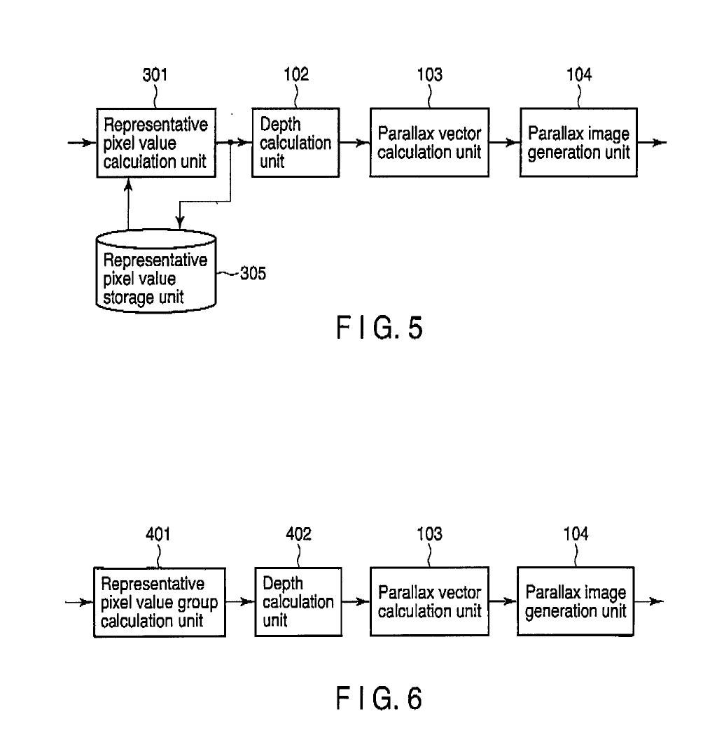

As shown in FIG. 5, a parallax image generation apparatus according to a second embodiment includes a representative pixel value calculation unit 301, depth calculation unit 102, parallax vector calculation unit 103, parallax image generation unit 104, and representative pixel value storage unit 305. The same reference numbers as in FIG. 1 denote the same parts in FIG. 5, and the differences between FIGS. 1 and 5 will mainly be described in the following explanation. Note that in this embodiment, an input image is one of a plurality of frames contained in a moving picture.

In the first embodiment, the depth of each target pixel value is determined in accordance with the distance from a representative pixel value. If the representative pixel value abruptly fluctuates with time, therefore, the depth of each target pixel value also abruptly fluctuates with time. The abrupt fluctuation in depth of each target pixel value with time not only strains the observer's eyes, but also adversely affects the quality of stereoscopy. Therefore, this embodiment reduces the abrupt fluctuation in representative pixel value with time.

The representative pixel value calculation unit 301 calculates a provisional value of a representative pixel value to be applied to an input image based on pixel values in at least a partial region of the input image. Note that this provisional value is the same as or similar to the representative pixel value calculated by the representative pixel value calculation unit 101 described previously. The representative pixel value calculation unit 301 reads out, from the representative pixel value storage unit 305, another representative pixel value to be applied to a frame different from the input image (typically, a frame immediately preceding the input image), and adds the different representative pixel value and the above-mentioned provisional value by weighting, thereby calculating a representative pixel value to be applied to the input image.

For example, the representative pixel value calculation unit 301 performs temporal blending on the representative pixel value in accordance with(18)

(U_{d},V_{d})ₜ′=α(U_{d},V_{d})ₜ+(1−α)(U_{d},V_{d})ₜ₋₁′ (18)

where the left side represents a representative pixel value to be applied to an input image, α represents a time constant (0≦α≦1), (U_{d},V_{d})ₜ represents the above-mentioned provisional value, t represents the frame number, and (U_{d},V_{d})ₜ₋₁′ represents a representative pixel value to be applied to a ((t−1)th) frame immediately preceding the input image. The smaller the time constant α, the smaller the fluctuation in representative pixel value with time between frames; the larger the time constant α, the more the feature of the input image is reflected (the closer the representative pixel value to the provisional value). Note that the representative pixel value to be applied to the input image may also be calculated by the weighted addition of the above-mentioned provisional value and a plurality of other representative pixel values to be applied to a plurality of other frames.

The representative pixel value storage unit 305 stores another representative pixel value to be applied to a frame different from an input image. Typically, the representative pixel value storage unit 305 stores a representative pixel value to be applied to a frame immediately preceding an input image.

As has been explained above, the parallax image generation apparatus according to the second embodiment calculates a representative pixel value to be applied to an input image by the weighted addition of a provisional value of a representative pixel value based on pixels in at least a partial region of the input image, and another representative pixel value to be applied to a frame different from the input image. Accordingly, the parallax image generation apparatus according to this embodiment can reduce the abrupt fluctuation in representative pixel value with time.

### Third Embodiment

As shown in FIG. 6, a parallax image generation apparatus according to the third embodiment includes a representative pixel value group calculation unit 401, depth calculation unit 402, parallax vector calculation unit 103, and parallax image generation unit 104. The same reference numbers as in FIG. 1 denote the same parts in FIG. 6, and the differences between FIGS. 1 and 6 will mainly be described in the following explanation.

The representative pixel value group calculation unit 401 calculates a plurality of (M) representative pixel values (to be also collectively referred to as a representative pixel value group in some cases hereinafter). The representative pixel value group calculation unit 401 calculates the representative pixel value group based on pixel values in at least a partial region of an input image. Typically, the representative pixel value group calculation unit 401 calculates the mode value of pixel values in a calculation region as explained in expressions (1) to (5) and their vicinities, as one representative pixel value in the representative pixel value group. In addition, the representative pixel value group calculation unit 401 searches a histogram for (M−1) remaining pixel values in descending order of frequency, and calculates representative pixel values (U_{d},V_{d})₁, . . . , (U_{d},V_{d})_{M}. That is, the pixel values (U_{d},V_{d})₂, . . . , (U_{d},V_{d})_{M} respectively indicating the second peak, . . . , and the Mth peak in the histogram are also taken into account as a part of the representative pixel value group in depth calculation.

The depth calculation unit 402 calculates a plurality of distances between a target pixel value and the plurality of representative pixel values, and converts the plurality of distances to a corresponding depth. Typically, as explained in expressions (8) to (10) and their vicinities, the depth calculation unit 402 calculates a plurality of distances D(x,y)₁, . . . , D(x,y)_{M} between the target pixel value and the plurality of representative pixel values. In addition, the depth calculation unit 402 searches for a minimum value of the plurality of distances D(x,y)₁, . . . , D(x,y)_{M} in accordance with

D(x,y)=min {D(x,y)₁, . . . , D(x,y)_{M}} (19)

Then, the depth calculation unit 402 converts D(x,y) to a depth by applying D(x,y) to expression (11) or (12). Although the conversion of the minimum value of the plurality of distances to the depth has been explained as an example, it is also possible to convert, e.g., the mean value, median value, or mode value of the plurality of distances, to the depth. Converting the minimum value to the depth means that the depth calculation according to the first embodiment is performed by selecting, from the representative pixel value group, one representative pixel value which is most similar to the target pixel value.

Note that as explained in the first embodiment, the calculations of background and foreground representative pixel values can be omitted by using prepared pixel values indicating specific colors as the background and foreground representative pixel values. That is, in this embodiment, the calculations of a part or the whole of the representative pixel value group can be omitted by preparing the part or whole of the representative pixel value group.

As has been explained above, the parallax image generation apparatus according to the third embodiment converts a plurality of distances between a target pixel value and a plurality of representative pixel values to a corresponding depth. Even when a plurality of largely different colors coexist in the background or foreground, therefore, the parallax image generation apparatus according to this embodiment can calculate a proper depth based on the color contrast between a plurality of representative pixel values and a target pixel value.

For example, a program for implementing the processing of each of the above-mentioned embodiments can be provided by storing the program in a computer-readable storage medium. The storage medium can take any storage form as long as the medium is a computer-readable storage medium capable of storing the program. Examples are a magnetic disk, an optical disc (e.g., a CD-ROM, CD-R, or DVD), a magnetooptical disc (e.g., an MO), and a semiconductor memory. Also, the program for implementing the processing of each embodiment may be stored in a computer (server) connected to a network such as the Internet, and downloaded to a computer (client) over the network.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A parallax image generation method comprising:
calculating a distance between a target pixel value of a target pixel contained in an input image and a representative pixel value, and calculating a depth of the target pixel in a stereoscopic space in accordance with the distance; and
generating, based on the depth, at least one parallax image corresponding to a view point different from that of the input image.

2. The method according to claim 1, wherein
the representative pixel value is a background representative pixel value located on at least a back side in the stereoscopic space reproduced by the at least one parallax image, and
the larger the distance, the smaller the depth to which the distance is calculated in the stereoscopic space.

3. The method according to claim 1, wherein
the representative pixel value is a foreground representative pixel value located on at least a fore side in the stereoscopic space reproduced by the at least one parallax image, and
the larger the distance, the larger the depth to which the distance is calculated in the stereoscopic space.

4. The method according to claim 1, further comprising calculating the representative pixel value based on pixel values in at least a partial region of the input image.

5. The method according to claim 4, wherein the representative pixel value is a mode value of the pixel values in the at least partial region of the input image, which is found from a histogram of the pixel values.

6. The method according to claim 4, wherein the representative pixel value is one of a mean value and a median value of the pixel values in the at least partial region of the input image.

7. The method according to claim 1, wherein the distance is one of a Euclidean distance and a Manhattan distance of a difference between the target pixel value and the representative pixel value.

8. The method according to claim 1, wherein the input image is one of a plurality of frames contained in a moving picture, and further comprising:
calculating a provisional value of the representative pixel value based on pixel values in at least a partial region of the input image; and
calculating the representative pixel value by performing weighted addition on the provisional value and another representative pixel value to be applied to a frame different from the input image.

9. A parallax image generation method comprising:
calculating a plurality of distances between a target pixel value of a target pixel contained in an input image and a plurality of representative pixel values, and calculating a depth of the target pixel value in accordance with the plurality of distances; and
generating, based on the depth, at least one parallax image corresponding to a view point different from that of the input image.

10. A parallax image generation apparatus, comprising:
a calculation unit configured to calculate a distance between a target pixel value of a target pixel contained in an input image and a representative pixel value, and calculating a depth of the target pixel in a stereoscopic space in accordance with the distance; and
a generation unit configured to generate, based on the depth, at least one parallax image corresponding to a view point different from that of the input image.
